(19) United States
(12) Patent Application Publication
(10) Pub. No.: US 2011/0198168 A1
(43) Pub. Date: Aug. 18, 2011

(54) ADJUSTABLE CONDUIT-END FITTING FOR A CABLE

(75) Inventors: Dean Dupei, White Lake, MI (US); Frank Hu, Shanghai (CN)

(73) Assignee: GM GLOBAL TECHNOLOGY OPERATIONS LLC, Detroit, MI (US)

(21) Appl. No.: 12/960,818

(22) Filed: Dec. 6, 2010

(30) Foreign Application Priority Data
Feb. 12, 2010 (CN) 201010142071.7

(51) Int. Cl. F16D 65/30; F16C 1/26; B23P 11/00

(52) U.S. Cl. 188/2 D; 74/502.4; 29/428

(57) ABSTRACT

A fitting assembly is provided for a cable having a wire and a conduit configured for being anchored to a bracket. The fitting assembly includes an externally cylindrical body that has a first end with a flexible portion, a second end with a first outer diameter, and an intermediate externally-threaded portion with a second outer diameter, wherein the conduit is fixedly retained by the body and the flexible portion is configured to anchor the fitting assembly to the bracket. The fitting assembly also includes a coil spring having an internal diameter that is larger than the second outer diameter and smaller than the first outer diameter, and an internally-threaded cap configured to engage the intermediate portion. The coil spring and the cap are configured to pass over the first end toward the second end, such that the spring preloads the cap when the cap is engaged with the intermediate portion.

### CROSS-REFERENCE TO RELATED APPLICATION(S)

This application claims the benefit of Chinese Application Serial No. 201010142071.7 filed Feb. 12, 2010, the entire contents of which is hereby incorporated by reference.

### TECHNICAL FIELD

The invention relates to adjustable fittings for cables, and, more particularly, to an adjustable fitting for a cable employing a conduit.

### BACKGROUND OF THE INVENTION

Cables are employed in different industries, including the automotive industry, for actuating and controlling various mechanisms. Such cables often incorporate conduits which serve a protective, as well as a force-reaction function. Typically, vehicular parking brake systems are actuated by cables with conduits. Various end fittings have been developed that enable the ends of a brake cable conduit to be secured to the vehicle support structure, such as to a mounting bracket.

Fixed cable length, rigid attachment points, and design and build tolerances inherent to fabricated vehicle structures may necessitate various adjustments after the cable has been installed in the vehicle. Without such post-installation adjustments, the cable may be incapable of applying appropriate force and therefore parking brake engagement in the subject vehicle.

To address such concerns, various mechanisms have been developed and employed in the automobile industry.

### SUMMARY OF THE INVENTION

A fitting assembly is provided for a cable having a wire and a conduit configured for being anchored to a bracket. The fitting assembly includes an externally cylindrical body that has a first end with at least one flexible portion, a second end having a first outer diameter, and an intermediate externally-threaded portion having a second outer diameter. The conduit is fixedly retained by the body, and the at least one flexible portion is configured to anchor the fitting assembly to the bracket. The fitting assembly also includes a coil spring having an internal diameter that is larger than the second outer diameter and smaller than the first outer diameter. Additionally, the fitting assembly includes an internally-threaded cap configured to threadably engage the intermediate externally-threaded portion. The coil spring and the cap are configured to pass over the first end toward the second end, such that the spring preloads the cap when the cap is threadably engaged with the intermediate portion.

According to an embodiment, the externally cylindrical body may be configured as a tube, such that the cable may extend through the body. Additionally, the at least one flexible portion may be configured to flex and recover after the cap is passed over the first end. The at least one flexible portion may furthermore be configured as multiple wings. Each resilient wing may have an angled surface adapted to engage the coil spring and the cap when the fitting assembly is put together, and a flat surface adapted to restrict the coil spring and the cap from reversing direction and disengaging the body.

The cap may include a knurled external surface adapted for being gripped by an operator. The externally cylindrical body may be formed from a plastic material. Additionally, the coil spring may have an external diameter that is smaller than the first outer diameter. A fitting assembly such as provided above, may be employed in a parking brake system of a motor vehicle.

Additionally, a method is disclosed for anchoring onto a vehicle a parking brake cable system having a conduit-end fitting assembly such as described above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a motor vehicle rear brake assembly employing a parking brake system with a conduit-end fitting assembly joined with a bracket;

FIG. 2A is an illustration of the conduit-end fitting assembly depicted in FIG. 1, showing the conduit-end fitting assembly in a disassembled state;

FIG. 2B is an illustration of the conduit-end fitting assembly depicted in FIG. 2A, showing a coil spring in an assembled state;

FIG. 2C is an illustration of the conduit-end fitting assembly depicted in FIG. 2A, showing the coil spring in the assembled state and a cap during the assembly operation;

FIG. 2D is an illustration of the conduit-end fitting assembly depicted in FIG. 2A, showing the conduit-end fitting assembly in an assembled state;

FIG. 3A is an illustration of the assembled conduit-end fitting assembly depicted in FIG. 2D being pressed into the bracket;

FIG. 3B is an illustration of the assembled conduit-end fitting assembly depicted in FIG. 2D, showing the conduit-end fitting assembly fully pressed into the bracket; and

FIG. 3C is an illustration of the assembled conduit-end fitting assembly depicted in FIG. 2D with the cap being tightened against the bracket.

### DESCRIPTION OF THE PREFERRED EMBODIMENTS

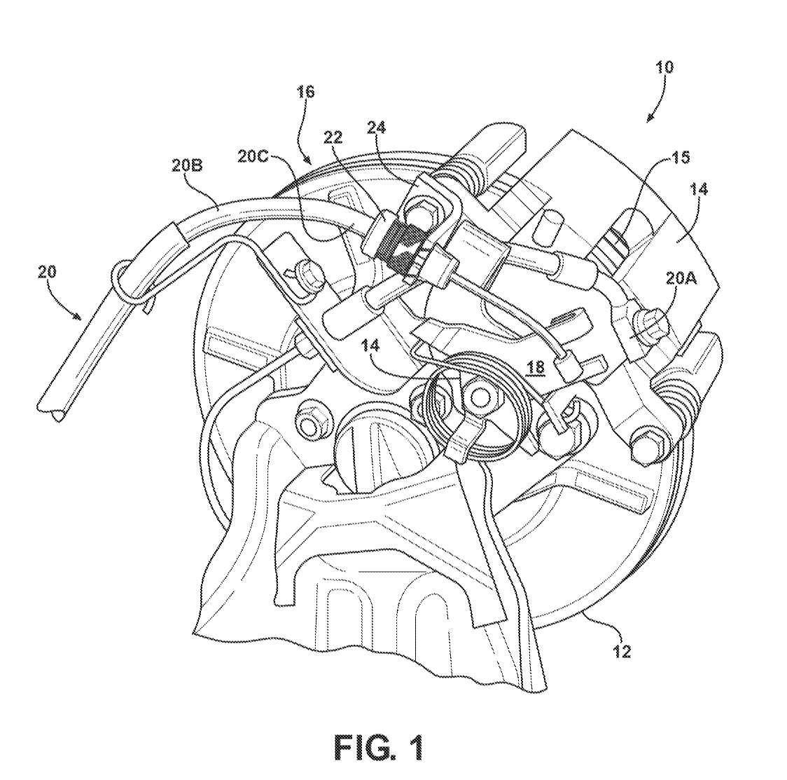

Referring to the drawings, wherein like reference numbers refer to like components, FIG. 1 shows rear brake assembly 10 for a motor vehicle. The rear brake assembly 10 is shown as a brake assembly for a rear axle of a motor vehicle (not shown), and typically includes a rotor 12, a caliper 14 with hydraulically energized pistons (not shown), and a main brake pad set 15. Generally, the brake assembly 10 becomes applied when the rotor 12 is squeezed by the brake pad set 15 when the caliper pistons are urged by the hydraulic pressure to extend toward the rotor. FIG. 1 depicts a disc brake assembly, but the rear brake assembly 10 may also be a drum brake assembly, as is understood by those skilled in the art.

The rear brake assembly 10 also includes a parking brake system 16 that typically employs mechanical actuation and completely bypasses the hydraulic actuation of the brake pad set 15 described above. Parking brake system 16 includes a friction braking mechanism, which may include either the brake pad set 15 or a distinct auxiliary set of parking pads (not shown) acting on the rotor 12. Parking brake system 16 additionally includes a cam lever 18 that mechanically transfers a parking brake actuation force to caliper 14 for squeezing rotor 12 via brake pad set 15. The parking brake actuation force is a tensile force generated by an operator of the vehicle, typically via a parking brake lever positioned inside the vehicle passenger compartment (not shown). Additionally, the parking brake actuation force may be a tensile force generated by an electric parking brake (EPB) system that is typically positioned externally to the passenger compartment, and regulated by a controller (not shown).

The tensile force generated by the vehicle operator is transferred to the brake pad set 15 via a brake cable 20. The brake cable 20 includes a multi-strand wire 20A arranged inside a sheath or a conduit 20B. Wire 20A is arranged to pull directly on the cam lever 18 thereby actuating the parking brake. Conduit 20B includes a fitting-end portion 20C. A conduit-end fitting assembly 22 is attached to the brake cable 20 at the fitting-end portion 20C. In turn, the conduit-end fitting assembly 22 is attached to a bracket 24 having an orifice 24A, wherein the conduit-end fitting assembly is inserted or pushed into and fixed inside the orifice. Bracket 24 is shown as attached to caliper 14, but may alternately be attached to any part of the vehicle body structure, such that a reaction force developed at the conduit 20B during the application of brake pad set 15 is transferred to a solid foundation.

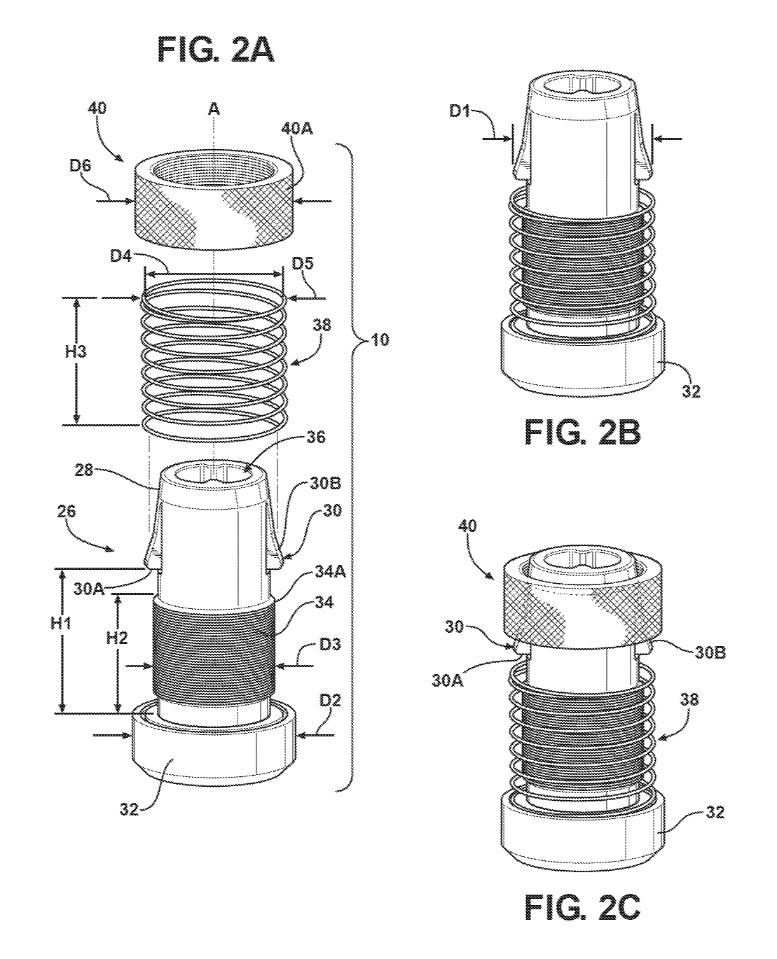

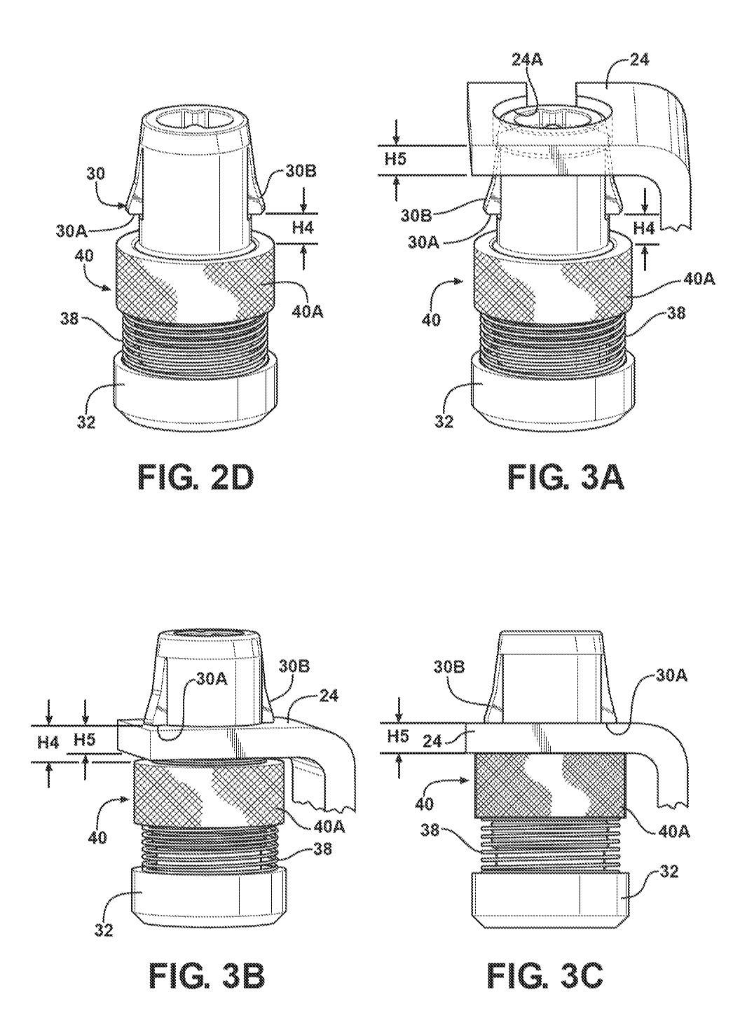

FIGS. 2A-2D depict in order the conduit-end fitting assembly 22 progressively coming together during an assembly sequence. Conduit-end fitting assembly 22 may be joined with the fitting-end portion 20C of the brake cable 20 either after or prior to the conduit-end fitting assembly having been put together according to the assembly sequence of FIGS. 2A-2D. FIG. 2A shows the conduit-end fitting assembly 22 in a fully disassembled state. An externally cylindrical body 26 of the conduit-end fitting assembly 22 includes a first end 28 having a flexible portion configured as resilient wings or projections 30. Wings 30 include a flat surface 30A and an angled surface 30B. The diameter of the circle circumscribed around the point where the flat surface 30A and the angled surface 30B meet is labeled D1.

The body 26 also includes a second end 32, configured as a flange that has an external or outer diameter D2. Flat surface 30A of the wings 30 is positioned at a height H1 from the second end 32. The body 26 additionally includes an intermediate externally-threaded portion 34 having an outer diameter D3. The top thread 34A of the intermediate portion 34 is positioned at a height H2 from the second end 32. The body 26 may be configured as a tube, having a through-hole 36 along axis A. The hole 36 is configured to accept and fixedly retain the fitting-end portion 20C of the conduit 20B, as well as to permit the wire 20A to pass through. Body 26 may be formed unitarily from an appropriate moldable plastic material, such as Nylon 6-6, capable of providing both resilient wings 30, and the strength necessary for the threaded intermediate portion 34.

FIG. 2A additionally shows a coil spring 38 having an internal diameter D4, an external diameter D5 and a free height H3. Diameter D4 is greater than diameter D3, and preferably (but not necessarily) greater than diameter of the circle D1, in order to permit the coil spring 38 to be pushed past the wings 30 and positioned around the intermediate portion 34. Diameter D4 is smaller than diameter D2, and diameter D5 is preferably (but not necessarily) also smaller than diameter D2, such that the coil spring 38 may be seated on, and constrained by the second end 32. Free height H3 of the coil spring 38 is preferably (but not necessarily) greater than height H2, and smaller than height H1. Also shown in FIG. 2A is a cap 40. The cap 40 includes an internal thread that corresponds to the external thread of the intermediate portion 34. The cap 40 additionally includes a knurled external surface 40A adapted to be gripped by an operator and to facilitate being threaded onto the intermediate portion 34 and tightened. External surface 40A has a diameter D6. Diameter D6 is greater than diameter D4, and is also preferably (but not necessarily) greater than diameter D5, to enable the cap 40 to pre-load and constrain coil spring 38 against second end 32.

FIG. 2B depicts the coil spring 38 being pushed or slipped past the wings 30, seated on the second end 32, and hence positioned around the intermediate portion 34. FIG. 2C depicts the cap 40 being engaged with the angled surface 30B of wings 30, wherein the cap is on the way to being pushed past the wings, as the wings deflect to permit the cap to pass toward the intermediate portion 34. The wings 30 initially deflect to permit the cap 40 to pass toward the coil spring 38, and then recover to their original shape. The angled surface 30B of each resilient wing 30 is adapted to engage the coil spring 38 and the cap when the conduit-end fitting assembly 22 is put together, and guide the coil spring and the cap 40 over the body 26. The flat surface, on the other hand, is adapted to restrict the coil spring 38 and the cap 40 from reversing direction and disengaging the body 26.

FIG. 2D depicts the cap 40 being threaded on to the intermediate portion 34, and in the process compressing the coil spring 38. The cap is shown being threaded onto the intermediate portion 34 until a gap H4 is created between the cap 40 and the flat surface 30A (FIG. 2D). The assembly sequence depicted in FIGS. 2A-2D may be performed at a manufacturer of the conduit-end fitting assembly 22 prior to the conduit-end fitting assembly being delivered to the vehicle manufacturer for installation onto the vehicle.

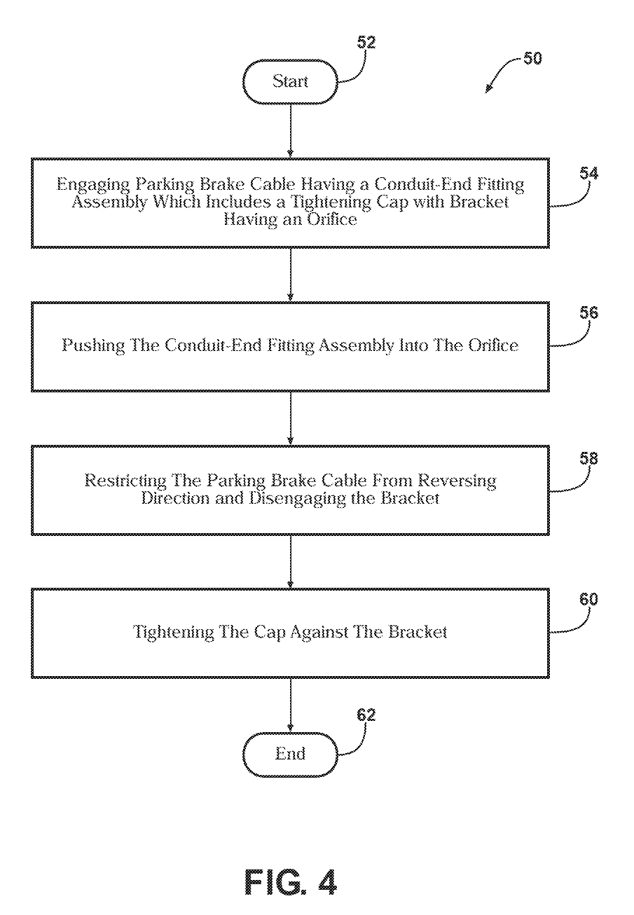

FIGS. 3A-3C depict in order the sequence of conduit-end fitting assembly 22 being attached to the bracket 24. Bracket 24 has a thickness H5, wherein H5 is smaller than the gap H4. FIG. 3A depicts the angled surface 30B of wings 30 being engaged with the orifice 24A of the bracket 24, wherein the wings are on the way to being pushed past the bracket. The wings 30 initially deflect to permit bracket 24 to pass toward cap 40 into the gap H4, and then recover to their original shape, such that the flat surface 30A restricts the conduit-end fitting assembly 22 from reversing direction and disengaging the bracket. FIG. 3B depicts the bracket 24 being seated in the gap H4, and taking up the majority, but not the entire gap between cap 40 and flat surface 30A.

FIG. 3C depicts cap 40 being tightened against the bracket 24, thereby eliminating any remaining gap between the bracket 24 and the flat surface 30A of the wings 30, such that the bracket is fixedly retained by the conduit-end fitting assembly 22. In the state when the bracket 24 is fixedly retained by the conduit-end fitting assembly 22, the coil spring 38 is still compressed, such that the coil spring provides a preload force urging the cap 40 toward the bracket. The preload force from coil spring 38 is beneficial for counteracting vibration likely to be seen by the vehicle structure during vehicle operation, and prevent unintentional loosening of cap 24.

FIG. 4 depicts a method 50 for assembling the conduit-end fitting assembly 22 described with respect to FIGS. 1-3C. The method commences in frame 52, and proceeds to frame 54, where the parking brake cable 20 is engaged with the bracket 24. As described above, the parking brake cable 20 includes a conduit 20B, a wire 20A disposed within the conduit, and the conduit-end fitting assembly 22 having an externally cylindrical body 26 including a first end 28 with multiple flexible wings 30. The externally cylindrical body 26 also has the second end 32 with the outer diameter D2, and an intermediate externally-threaded portion 34 with the outer diameter D3.

As described with respect to FIG. 1, conduit 20B is fixedly retained by the body 26, and the wings 30 are configured to anchor the conduit-end fitting assembly 22 to the bracket 24. The conduit-end fitting assembly 22 also includes coil spring 38 having internal diameter D4 that is larger than the diameter D3, and smaller than the diameter D2. Furthermore, conduit-end fitting assembly 22 includes internally-threaded cap 40 configured to threadably engage the intermediate externally-threaded portion 34. Coil spring 38 and cap 40 are configured to be passed over the wings 30 in the direction of the second end 32, such that the coil spring preloads the cap when the cap is threadably engaged with the intermediate portion 34. Bracket 24 is fixed on the vehicle and includes orifice 24A adapted to accept the conduit-end fitting assembly 22 for anchoring the brake cable 20 to the vehicle support structure.

From frame 54 the method proceeds to frame 56, where the conduit-end fitting assembly 22 is pushed into the orifice 24A, such that the wings 30 deflect to permit the conduit-end fitting assembly to pass through the orifice. Following the conduit-end fitting assembly 22 passing through the orifice 24A, in frame 58 the wings 30 recover their original shape, thus assuming the position where the flat surface 30A restricts the conduit-end fitting assembly from reversing direction and disengaging the bracket 24.

After frame 58, the method moves on to frame 60, where the cap 40 is tightened against the bracket 24. The action of tightening the cap 40 against the bracket 24 has the effect of the bracket becoming fixedly restrained by the conduit-end fitting assembly 22. Additionally, the coil spring 38 remains compressed by the cap 40, such that the spring provides a preload force urging the cap toward the bracket 24, thus ensuring that the tight connection between the cap and the bracket is retaining during vehicle operation. Following frame 60 the method proceeds to frame 62 where the method is completed.

Although the conduit-end fitting assembly 22 and method 50 are described with respect to the brake assembly 10 for a motor vehicle, nothing precludes the conduit-end fitting assembly from being employed in any other system within the vehicle, and in any industry other then automotive, where a cable with a conduit may be used.

While the best modes for carrying out the invention have been described in detail, those familiar with the art to which this invention relates will recognize various alternative designs and embodiments for practicing the invention within the scope of the appended claims.

1. A fitting assembly for a cable having a wire and a conduit configured for being anchored to a bracket, the fitting assembly comprising:
an externally cylindrical body including a first end having at least one flexible portion, a second end having a first outer diameter, and an intermediate externally-threaded portion having a second outer diameter, wherein the conduit is fixedly retained by the body, and the at least one flexible portion is configured to anchor the fitting assembly to the bracket;
a coil spring having an internal diameter that is larger than the second outer diameter and smaller than the first outer diameter; and
an internally-threaded cap configured to threadably engage the intermediate externally-threaded portion;
wherein the coil spring and the cap are configured to pass over the first end in the direction of the second end, such that the coil spring preloads the cap when the cap is threadably engaged with the intermediate externally-threaded portion.

2. The fitting assembly of claim 1, wherein the externally cylindrical body is configured as a tube, such that the wire may extend through the body.

3. The fitting assembly of claim 1, wherein the at least one flexible portion is adapted to flex and recover after the cap is passed over the first end.

4. The fitting assembly of claim 3, wherein the at least one flexible portion is configured as multiple resilient wings, each resilient wing having an angled surface adapted to engage the coil spring and the cap, and a flat surface adapted to restrict the coil spring and the cap from reversing direction and disengaging the body.

5. The fitting assembly of claim 1, wherein the cap includes a knurled external surface adapted for being gripped by an operator.

6. The fitting assembly of claim 1, wherein the externally cylindrical body is formed from a plastic material.

7. The fitting assembly of claim 1, wherein the coil spring has an external diameter that is smaller than the first outer diameter.

8. A parking brake system for maintaining a motor vehicle in a stationary position, parking brake system comprising:
a friction braking mechanism;
a brake cable having a conduit and a wire disposed within the conduit, the brake cable adapted for actuating the friction braking mechanism;
a bracket adapted to anchor the brake cable to the vehicle;
a fitting assembly having:
an externally cylindrical body including a first end having at least one flexible portion, a second end having a first outer diameter, and an intermediate externally-threaded portion having a second outer diameter, wherein the conduit is fixedly retained by the body, and the at least one flexible portion is configured to anchor the fitting assembly to the bracket;
a coil spring having an internal diameter that is larger than the second outer diameter and smaller than the first outer diameter; and
an internally-threaded cap configured to threadably engage the intermediate externally-threaded portion;
wherein the coil spring and the cap are configured to be passed over the first end in the direction of the second end, such that the coil spring preloads the cap when the cap is threadably engaged with the intermediate externally-threaded portion.

9. The parking brake system of claim 8, wherein the externally cylindrical body is configured as a tube, such that the wire extends through the tube.

10. The parking brake system of claim 8, wherein the at least one flexible portion is adapted to flex and recover after the cap is passed over the first end.

11. The parking brake system of claim 10, wherein the at least one flexible portion is configured as multiple resilient wings.

12. The parking brake system of claim 8, wherein the cap includes a knurled external surface adapted for being gripped by an operator.

13. The parking brake system of claim 8, wherein the externally cylindrical body is formed from a plastic material.

14. The parking brake system of claim 8, wherein the coil spring has an external diameter that is smaller than the first outer diameter.

15. A method for anchoring a parking brake cable system in a vehicle, the method comprising:
engaging a parking brake cable with a bracket fixed on the vehicle, wherein the parking brake cable includes a conduit and a wire disposed within the conduit, and a conduit-end fitting assembly;
wherein the conduit-end fitting assembly includes:
an externally cylindrical body including a first end having at least one flexible portion, a second end having a first outer diameter, and an intermediate externally-threaded portion having a second outer diameter, wherein the conduit is fixedly retained by the body, and the at least one flexible portion is configured to anchor the fitting assembly to the bracket;
a coil spring having an internal diameter that is larger than the second outer diameter and smaller than the first outer diameter;
and an internally-threaded cap configured to threadably engage the intermediate externally-threaded portion, such that the coil spring and the cap are configured to be passed over the first end in the direction of the second end, and the coil spring preloads the cap when the cap is threadably engaged with the intermediate externally-threaded portion; and
wherein the bracket includes an orifice adapted to accept the conduit-end fitting assembly for anchoring the brake cable to the vehicle;
pushing the first end of the conduit-end fitting assembly into the orifice to thereby deflect the at least one flexible portion and permit the first end to pass through the orifice,
restricting the parking brake cable from reversing direction and disengaging the bracket by having the at least one flexible portion recover after the first end has passed through the orifice; and
tightening the cap against the bracket, wherein the bracket is fixedly restrained by the conduit-end fitting assembly, and the coil spring provides a preload force urging the cap toward the bracket.

16. The method of claim 15, wherein the externally cylindrical body is configured as a tube, such that the wire may extend through the body.

17. The method of claim 15, wherein the at least one flexible portion is configured as multiple resilient wings, each resilient wing having an angled surface adapted to engage the orifice, and a flat surface adapted to restrict the first end from reversing direction and disengaging the bracket.

18. The method of claim 15, wherein said tightening the cap against the bracket is facilitated by a knurled external surface provided on the cap for being gripped by an operator.

19. The method of claim 15, wherein the externally cylindrical body is formed from a plastic material.
